(19) United States
(12) Patent Application Publication
(10) Pub. No.: US 2003/0158816 A1
(43) Pub. Date: Aug. 21, 2003

(54) Internet-based content billing and protection system

(75) Inventor: Larry O?apos;Neal Rouse, San Diego, CA (US)

Correspondence Address: LARRY O'NEAL ROUSE, 641 21ST #5, San Diego, CA, 92102, US

(73) Assignee: Emediapartners, Inc., San Diego, CA

(21) Appl. No.: 10/338,472

(22) Filed: Jan. 8, 2003

Related U.S. Application Data
(60) Provisional application No. 60/347,207, filed on Jan. 9, 2002.

(51) Int. Cl. G06F 17/60

(52) U.S. Cl. 705/51

(57) ABSTRACT

A software system and a method for a Internet-based Content Billing and Protection System capable of both selling and delivering in Real Time Protected Content such as a live or archived on-demand Webcast on the Internet to a Client using dynamically generated Web pages and Encoded Links that cannot be Bookmarked, copied, displayed, exported or otherwise made public to the Client or a Subscriber by the Web Browsers, Players, Browser Plug-ins, or other Client Side programs. The invention operates on a Web Server while the Protected Content can reside on any Content Server, including a Streaming media Webcast Server such as a Windows Media Services Webcast Server.

### CROSS REFERENCE TO RELATED APPLICATION

We claim priority based on a previous Provisional Application filed Jan. 9, 2002, application number 60/347,207.

### FIELD OF THE INVENTION

This invention relates to Internet Content such as Webcasting and Electronic Ecommerce for the purpose of selling proprietary Content to authorized Subscribers on the Internet or other interactive network. Specifically, this invention relates to protecting Content Server Links, including but not limited to Webcast Server Links, from piracy or unauthorized use.

### BACKGROUND OF THE INVENTION

With the increasing popularity of the Internet and the World Wide 20 Web, it has become common for Internet Content Merchants to set up Web sites for marketing and selling of proprietary Content such as Streaming media. Access to such Streaming media Content on these Web sites is also used for attracting visitors and potential customers.

One problem encountered by Internet Content Merchants is an inability to protect the Links to the Content which visitors can easily Bookmark or otherwise gain direct access to such Content without having to go through the merchants' control mechanisms, avoiding compensating the merchants for providing such Content either through direct purchase or indirectly through adding traffic to merchants' Web sites. Widely available free Players can be used to make these Bookmarks and even to display the Links to the merchants' proprietary Content.

Another problem commonly faced by Internet Content Merchants is the inability to charge Internet customers in Real Time for the delivery and actual metered use of Content and at the same time restrict customer access to such Content while preventing piracy or unauthorized access. The present invention addresses these and other problems.

### SUMMARY OF THE INVENTION

The present invention (the “Invention”) provides a software system and a method for a Internet-based Content Billing and Protection System capable of both selling and delivering in Real Time Protected Content such as a live or archived on-demand Webcast on the Internet to a Client using dynamically generated Web pages and Encoded Links that cannot be Bookmarked, copied, displayed, exported or otherwise made public to the Client or a Subscriber by the Web Browsers, Players, Browser Plug-ins, or other Client Side programs. In addition the Invention operates on a Web Server while the Protected Content can reside on any Content Server, including but not limited to a Streaming media Webcast Server such as a Windows Media Services Webcast Server.

The Invention uses a Web Server such as the Apache Web Server, a Dynamic Web Page Program Server Side engine such as the Aestiva embedded tag HTMLOS programming language, HTML, a Web page Client-Side Scripting language such as JavaScript, and a computer operating system that allows for System Scripts and URL redirection such as Linux. The Invention Web application works with Web Browsers such as Netscape and Internet Explorer Browsers 4.0 and higher. Protection for Content Links works with but is not limited to using a Streaming media format such as Windows Media Technology format and standalone Streaming media Player such as Windows Media Player or a Browser Plug-in via a Web page embedded version of the same or similar Player.

### BRIEF DESCRIPTION OF DRAWINGS

FIG. 1 is a timing diagram of the Internet-based Content Billing and Protection System of the present invention, which illustrates how a Client requests and gains controlled access to a protected Webcast, assuming, in the case of a Subscriber service or paid Content service being used, that the subscriber has enough Credits purchased to allow the request to be processed;

FIG. 2 is an events diagram of the Internet-based Content Billing and Protection System of the present invention, showing a Start Request Connections Diagram which illustrates how a Client Browser and Player interact with the Internet-Based Content Billing and Protection System service Web Server and the protected Webcast Server;

FIG. 3 is an events diagram of the Internet-based Content Billing and Protection System of the present invention, showing a Stop Request Connections Diagram which illustrates how a Client stops the Protected Webcast; and

FIG. 4 is an events diagram of the Internet-based Content Billing and Protection System of the present invention, showing a URL Redirection diagram which illustrates how a Player receives a direct Stream connection to the Protected Link of a Protected Webcast Server in response to the Player first sending a request to the Internet-based Content Billing and Protection System Web Server.

### DETAILED DESCRIPTION OF A PREFERRED EMBODIMENT

To facilitate a complete understanding of the Invention, the description of a preferred embodiment is arranged within the following sub-sections:

1. GLOSSARY OF TERMS AND ACRONYMS

2. OVERVIEW OF SYSTEM COMPONENTS AND OPERATION

3. WEB SERVER RECONFIGURATION

4. SYSTEM FILE PERMISSIONS

5. ACCESS ELEMENTS

6. ACCESS PATH PROTECTION

7. ACCESS TIME PERIOD

8. ENCODED CONTENT LINKS

9. SUBSCRIBER/CLIENT CONTENT LINKS

10. ACCESS PATH ACTIVATION

11. PLAYER STREAM ACQUISITION

12. ACCESS PATH RECYCLING

13. BILLING

14. CONCLUSION

15. WHAT IS NEW

Included as Appendix A are documents that further illustrate a preferred embodiment of the invention. These materials form part of the disclosure of the specification and are fully incorporated herein.

1. Glossary of Terms and Acronyms

The following terms and acronyms are used in the detailed description:

Access Elements. Physical Server Side components such as files, file entries and directories used to access a requested connection, for example, to a Protected Webcast.

Access Path. A combination of Access Elements that can allow one URL to be redirected to a second URL for the purpose of protecting the identity of the second URL.

Access Strings. The alphanumeric names of Server Side elements as opposed to the physical elements themselves such as files, file entries and directories.

Access Time Period. A controlled period of time during which a Player may connect to Content such as a Protected Webcast Stream using an Access Path.

Billing. Server Side tabulation through timing or other means of the Clients' estimated or actual use of Protected Content such as a Webcast for the purpose of deducting Credits in response to the Client requesting that the protected Webcast and Billing both start together and then stop together. Alternately Billing may be determined and collected in advance of Client access.

Bookmark. A saved URL that allows a Browser, Stream media Player or other such Client Side program to reaccess a Web site or Streaming media Webcast. Such Links can be stored for later use by both Browsers and Stream media Players (in the case of Webcast URLs).

Browser. See Client-Server definition.

Client-Server. A model of interaction in a system in which a program at one site sends a request to a program at another site and waits for a response. The requesting program is called the “Client,” and the program which responds to the request is called the “Server.” In the context of the World Wide Web (discussed below), the Client is a “Web Browser” (or simply “Browser”) which runs on a computer of a Subscriber; the program which responds to Browser requests by serving Web pages is commonly referred to as a “Web Server.”

Client Side. Elements such as programs, files and directories that reside and operate on the local computer where the Client resides as opposed to residing and operating on the Web or Webcast Server.

Content. Files, text, graphics, audio, video, and multimedia delivered to Clients over the Internet, using but not limited to Web pages and Streams.

Content Merchant. A merchant whose business is to sell Content on the Internet. Such Content may include but not be limited to files and Streaming media.

Content Provider. A merchant or other Content owner who makes Content available to Clients and/or Subscribers.

Content Server. A Server dedicated to sending Content to Clients.

Control Page. A Web page used by a Subscriber to purchase Credits and to request the starting and stopping of a paid Webcast with the associated Billing to Credits thereof. A similar page can be used without the purchase requirement.

Credits. Prepurchased units of access time a Client may use to connect to a Protected Webcast.

Dynamic Web Page Program. A Server Side program that executes special program language statements which may be embedded in the HTML Web page source code or reside solely on a Web Server. Examples of this include but are not limited to Aestiva HTMLOS, PHP, ASP, and Perl. These programs have the capability of dynamically generating Web pages and other Content from special Server side code, programs, templates, Web page components, databases, and other Server side components in such a manner that results in the Web Content being especially created for and in response to a Client request and not just taken from a Web directory on a Server and sent to the Client as static Content. For more information on Dynamic Web Page Program languages see online info at aestiva.com and php.org.

Electronic Ecommerce. The buying and selling of products and services on the Internet. Payment for and delivery of these products and services may or may not occur in Real Time.

Email. Electronic messaging between Clients over the Internet.

Encoded. A property by which a unique name is composed of random numbers combined with text and made to exist or be usable temporarily for one Client only and furthermore be difficult to predict. This type of encoding is not to be confused with a Webcast Stream encoder.

Filepushlink. A Dynamic Web Page Program code mechanism that can create an Encoded Link whereby and subsequently through a related “Filepush” code mechanism the Contents of a file may be “Pushed” or sent to a Client in response to the Client's request for the Encoded Link. The identity of the file is not revealed. In addition any number of other Dynamic Web Page Program code operations may be executed in response to the Client Link request just prior to the final Push. Nothing appears in the Web page source code but the Encoded Link.

Free Webcast. A Webcast that may or may not be controlled like a paid Webcast but for which the Subscriber or Client is not charged.

Hackers. Internet users who attempt to gain unauthorized access to Protected Content or Content Server and/or the Internet-Based Content Billing and Protection System Web Server.

Helper Application. A Client Side program that processes content at the request of a Client such as a Browser. A Player would be a Helper Application, for example.

HTML (HyperText Markup Language). A standard coding convention and set of codes for attaching presentation and linking attributes to informational Content within documents. (HTML 2.0 is currently the primary standard used for generating Web documents.) During a document authoring stage, the HTML codes (referred to as “tags”) are embedded within the informational Content of the document. When the Web document (or HTML document) is subsequently transferred from a Web Server to a Browser, the codes are interpreted by the Browser and used to parse and display the document. Additionally in specifying how the Web Browser is to display the document, HTML tags can be used to create Links to other Web documents (commonly referred to as “hyperlinks”). For more information on HTML, see Ian S. Graham, The HTML Source Book, John Wiley and Sons, Inc., 1995 (ISBN 0471-11894-4). HTTP (HyperText Transport Protocol). The standard World Wide Web click-Server protocol used for the exchange of information (such as HTML, documents, and Client requests for such documents) between a Browser and a Web Server. HTTP includes a number of different types of messages which can be sent from the Client to the Server to request different types of Server actions. For example, a “GET” message, which has the format GET <URL>, causes the Server to return the document or file located at the specified URL.

Hyperlink. A navigational Link from one document to another, or from one portion (or component) of a document to another. Typically, a hyperlink is displayed as a highlighted word or phrase that can be selected by clicking on it using a mouse to jump to the associated document or documented portion.

Hypertext System. A computer-based informational system in which documents (and possibly other types of data entities) are linked together via hyperlinks to form a Subscriber navigable “web.”

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

Intranet. A network of local computers which may be connected to the internet but which do not rely exclusively upon the internet for their interconnections and exchange of programs and data.

JavaScript. A script-based programming language that supports the development of both Client and server components of Web based applications. Its event handling capabilities provide greater control over the user interface than HTML alone. For more information on Javascript, see Gary Masters, HTML Complete, Sybex, Inc., 1999 (ISBN 0-7821-2467-4).

Java. A simple, object-oriented, distributed, interpreted, robust, secure, architecturally neutral, portable, high-performance, multi-threaded, dynamic programming language that will work across the Internet and on an intranet. For more information on Java, see Gary Masters, HTML Complete, Sybex, Inc., 1999 (ISBN 0-7821-2467-4).

Links. URLs and references that Clients and Servers can use to convert into URLs, including the specification of a particular position in, component or other functional aspect of a Web page, Server, or other resource on the Internet.

Metafile. A text file containing text, program code and/or one or more URLs used by a standalone or embedded Player to attempt to connect to a Webcast Stream or other Content.

Overlay. Dynamic Web Page Program code that runs in response to Client selection of Web page Links previously Encoded by the Dynamic Web Page Program.

Player. A Client Side program (e.g. Windows Media Player) that 5 connects to and presents a Webcast Stream or other Content. Such a Player may be a standalone Player or an embedded Player which is part of a Web page and depends upon a Browser Helper Application called a Plug-in. The term “Player” is used to refer to either a standalone Player or embedded Player or both.

Plug-in. A Browser Helper Application that allows an embedded Player to connect to and present a Webcast Stream or other Content.

Popup Box. A new Web page created by an-existing Web page Script.

Protected Webcast. A Webcast intended for use by only authorized Subscribers, for example, as in pay-per-view or subscription based Internet radio or only by authorized users.

Protected Content. Content intended for use by only authorized Subscribers, for example, as in pay-per-view or subscription based Internet radio or only by authorized users.

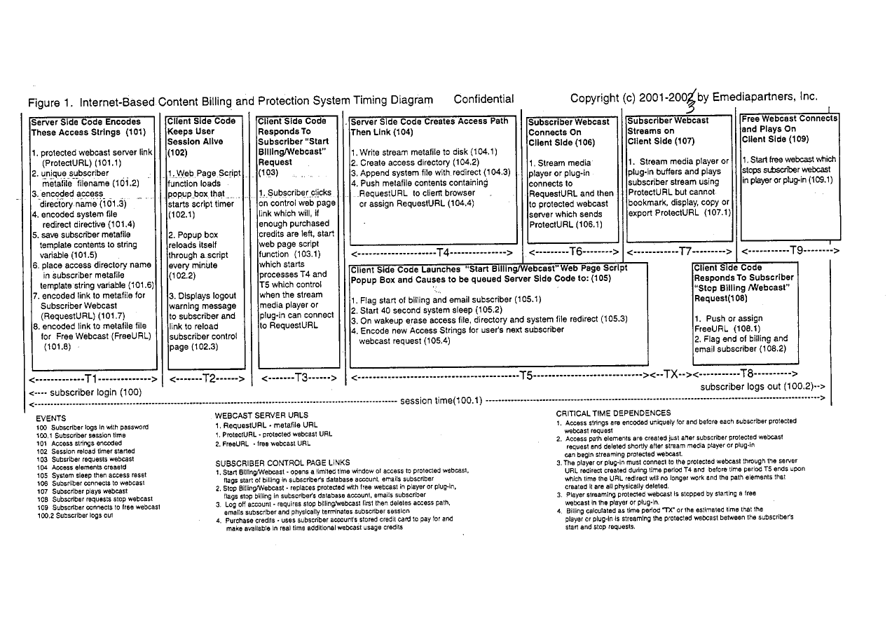

Protected Link. A URL that provides a direct connection to a protected Webcast Stream residing on a Webcast or Web Server. This variable is labeled ProtectURL in FIG. 1.

Push. A means whereby a Server Side function delivers a specified file's Contents in response to a Client Side Link request, for example, a Metafile such as a Windows Media ASX file. The original source file's Server Side identity is not revealed to the Client.

Real Time. An event or process occurring during or very near the present as opposed to occurring in the future. Buying something on the Internet would be said to occur in Real Time, for example, if payment were collected electronically through an Internet direct deposit credit card secure banking gateway made available to a Client for submitting the necessary Billing information.

Redirect Directive. A text entry in a System File or files that allows a Web Server to pass on or redirect a Client's URL request to a second URL which may point to a Webcast Server. The second URL contains the return location of the Client, allowing the destination Server of the second URL to respond directly to the Client's original request with the substituted URL.

Script. A special programming language embedded in HTML Web pages that provides enhanced functionality and interactivity. Such “Scripting” may run Client Side (e.g. JavaScript) or Server Side (e.g. Aestiva, PHP, ASP).

Secure Web Page. A Web page that can be requested from a Web Server using the “https://” URL protocol which causes the Client Browser to encrypt all data submitted to the Server from that same page, using a secure form or secure URL.

Server. See Client-Server definition.

Server Side. Elements such as programs, files and directories that reside and operate on the Web or Webcast Server as opposed to residing and operating on the Client's local computer;

Session. An Internet user identity based on a particular Client connection cooperatively maintained between the Client and the Server that allows Web pages and Client requests to continue to be updated and responded to by either side. When the Client or Server unilaterally terminates the connection the Session ends.

SRC Assignment. An embedded Player's Webcast Stream URL parameter is set equal to a specific URL controlled on the Server side. This variable is labeled RequestURL in FIG. 1.

Stream. The digital data that is continually transmitted to a player or Client which upon receipt of the data converts the data to a final intended Client Side presentation such as an audio, video, or multimedia presentation. Such data may be transmitted from an archived file source on either a Web or a Webcast Server. A live Stream is transmitted from a Webcast Server that receives and retransmits Streams based on a single Stream created by a Stream Encoder at the site of the live event. A live event is sometimes used to refer to an event that is actually happening in real time, but sometimes it refers to the fact that an encoder is sending the Stream from data converted in real time from some media storage device such as a CD or VCR as opposed to encoding the Stream as an archived file to be uploaded to a server. A client may start playing a live stream but cannot determine what Content is sent at the beginning of the stream as opposed to an archived file stream which is “on-demand” and can be so determined and even made to backup and repeat sections of Content. (While this term is intended to refer to what is now commonly known as a Stream, it is also intended to encompass variations which may be made in the future, including changes and additions to existing standard protocols and technology.)

Stream Encoder. A computer and program capable of converting audio and/or video input into a Stream made available to the internet through either a direct live connection to the Stream Encoder or to a Server Side file created from the Stream Encoder output.

Streaming. Continuous delivery of content such as audio, video and multimedia.

Subscribers. Internet users who register or enroll for the purpose of using sanctioned Client Side programs such as Browsers and Players to access protected Webcasts, Content or other services.

System File. A Server Side file used by the Server's operating system to control use of, access to and/or operation of Server Side programs and access elements such as Web site and URL requests from Clients.

System Script. A Script that runs as an operating system command, executing such functions as appending/deleting text to and from System Files and creating/deleting file directories (e.g. bsh Scripts in a Linux system).

Underlay. Dynamic Web Page Program code that runs prior to the Web page being sent to the Client.

URL (Uniform Resource Locator). A unique address which fully specifies the location of a file or other resource on the Internet. The general format of a URL is protocol://machine address:port/path/filename. The port specification is optional, and if none is entered by the Subscriber, the Browser defaults to the standard port for whatever service is specified as the protocol. For example, if HTTP is specified as the protocol, the Browser will use the HTTP default port of 80. If HTTPS is specified as the protocol, the Browser will use the HTTPS default port of 81.

Webcast. Presentation of continuous audio, video or multimedia Content by a Browser via a Plug-in or by a standalone Player.

Webcast Server. A Server dedicated to sending Streams to Clients.

Web Server. A Server dedicated to sending Web site components to Clients and to processing URLs sent to it by Clients.

Web Site. A computer system that serves informational Content over its network using the standard protocols of the World Wide Web. Typically, a Web site corresponds to a particular Internet domain name, such as Subscriberonline.com, and includes the Content associated with a particular organization. As used herein, the term is generally intended to encompass both (i) the hardware and software Server components that serve the informational Content over the network, and (ii) the “back end”hardware/software components, including any non-standard or specialized components, that interact with the Server components to perform services for Web site Clients and Subscribers.

World Wide Web (“Web”). Used herein to refer generally to both (i) a distributed collection of interlinked, user viewable hypertext documents (commonly referred to as Web documents or Web pages) that are accessible via the Internet, and (ii) the Client and Server software components which provide Subscriber access to such documents using standardized Internet protocols. Currently, the primary standard protocol for allowing applications to locate and acquire Web documents is HTTP, and the Web pages are Encoded using HTML. However, the terms “Web” and “World Wide Web” are intended to encompass future markup languages and transport protocols which may be used in place of (or in addition to) HTML and HTTP.

2. Overview of System Components and Operation

FIG. 1 illustrates the general architecture and timing relationships of an Internet-based Content Billing and Protection System that operates in accordance with the present Invention and using as an example only a Streaming Webcast Content to be protected.

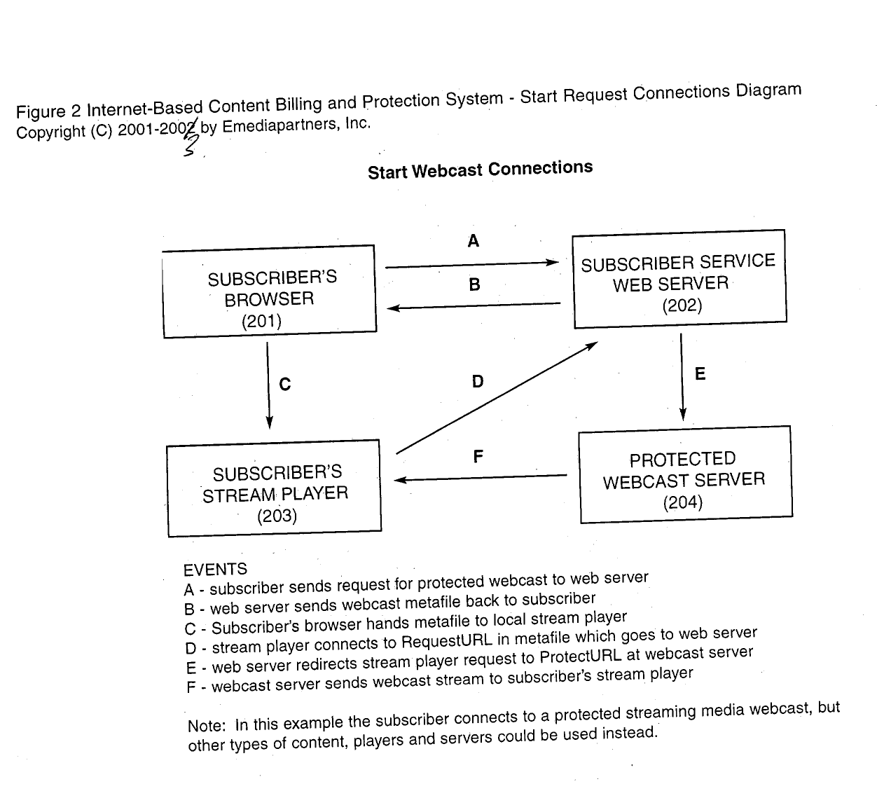

The system includes a Subscriber computer with Browser (Item 201 in FIG. 2) and Player (Item 203 in FIG. 2), a Subscriber service Web Server (Item 202 in FIG. 2) operating the Content Subscriber Web site, and a Content Server such as a Webcast Server (Item 204 in FIG. 2) which provides the Protected Content such as a Webcast Stream all of which are linked together by the Internet (see FIG. 2). The customer computer may be any type of computing device that allows a Subscriber to interactively browse Web sites via a Web Browser. For example, the Subscriber computer may be a personal computer (PC) that runs the Windows 2000 or XP operating system.

The Internet-based Content Billing and Protection System Web Server (Item 202 in FIG. 2) operates a Web site that provides various functionality for allowing Subscribers to purchase Credits and use Protected Content, including but not limted to a Protected Webcast on the Internet. As described below, the Internet-based Content Billing and Protection System Web Server (Item 202 in FIG. 2) includes software for signups that implements a Subscriber registration process, password protected login software for limiting use of the Web site to legitimate Subscribers, and a Subscriber control Web page that allows the Subscriber to among other things purchase Credits, edit signup account information, get help, start and stop Billing in conjunction with the use of a Protected Webcast, and Client log out. Subscriber Login Web Page Illustrates a secure Web page controlled by the Subscriber service Web Server and where a Subscriber uses a Subscriber name and password to gain access to its Subscriber control Web page and account information. Subscriber Control Web Page Illustrates a secure Web page controlled by the Subscriber service Web Server and where the Subscriber may purchase Credits, edit account info, get help, start and stop Billing together with the Protected Webcast, and finally to log off the system.

There are several system components that combine with a primary Content Server Protected Link protection facility in order to provide a complete Subscriber application capable of selling and delivering Protected Content such as a Webcast on the Internet. These include the following.

Subscribers sign up on a secure Web page by entering personal data, including a valid credit card which is verified in Real Time before a login account is created and Emailed to the Subscriber. Subscriber Signup Web Page Illustrates a secure Web page controlled by the Subscriber service Web Server and where the Subscriber may register to create a private account to be accessed via a Subscriber name and password which are Emailed to the Subscriber upon verification of the Subscriber's credit card. This credit card is subsequently used by the Subscriber to purchase Webcast time Credits on a secure Subscriber Control Web through a “two click” purchase Link. The first calculates the amount of time to be purchased and displays the purchase amount with a second Link to a direct deposit banking gateway. This second Link uses the Subscriber's credit card info found in the Subscriber account database record created by the Subscriber during the signup process. The Subscriber may also control the start and stop of Protected Content Billing and use, edit account information, monitor purchases and remaining time Credits, and log out of the account all through this same Subscriber Control Web page.

A Dynamic Web Page Program creates various Encoded URLs and Links to Web pages, files and other Internet resources. These special URLs and Links expire after a preset time period controlled by the Internet-Based Content Billing and Protection System Web Server, providing an additional security measure. For each Subscriber these URL's and Links are controlled by a unique Session identity. The Session identity is maintained on the Server Side and when it is terminated the Client can no longer gain access to any of the URLs or Links or otherwise use the Web pages so controlled. When the Subscriber leaves the Web site the Subscriber Session expires immediately while any URLs or Links copied by the Subscriber will expire after the Server determined time period. The URLs and Links will not work with any other Subscriber on a different computer or a different Session.

While the Dynamic Web Page Program Subscriber Session provides security it also can interfere with normal Subscriber functions such as “Start Billing/Webcast”, edit account info and logging off the account (See FIG. 1). If the Subscriber leaves the Session prior to closing Billing for a paid Webcast, using the Player, for example, the Subscriber must remain locked out for a period of time in order to defeat piracy of the paid Webcast. Therefore at the beginning of each Session a Script generated Popup Box is launched and this box contains additional Script code that reloads the Subscriber Session every one minute, keeping the Session alive (See Item 102 in FIG. 1). If Subscriber Credits are found to be zero at the time of this reload, then the Billing is closed and the Protected Content connection is stopped. It also contains a Link that can be used to reload the main Subscriber Control Page where the Subscriber purchases Webcast Credits, starts and stops Billing and the paid Webcast, edits account information, gets help, and logs off the account when finished.

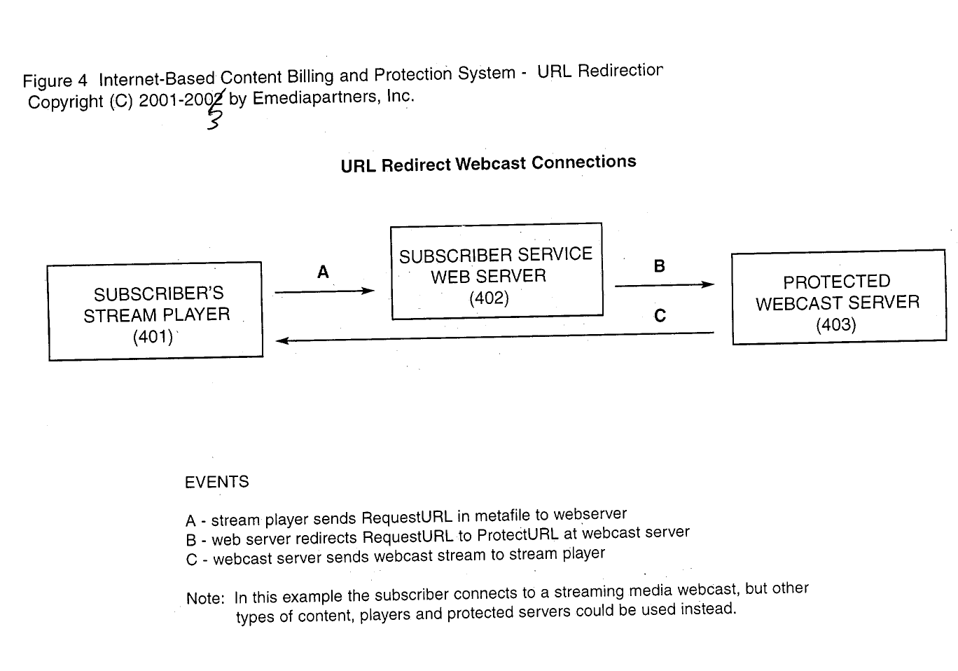

The Client Side Player may be a standalone program that acts as a helper application which processes Content at the request of the Browser, or a second variation uses an embedded Player which, in the case of the Protected Content being of a continuous nature like a Webcast, eliminates the possibility of the Subscriber Content use continuing after the Client Web Session ends. When the Session expires for whatever reason the Web page that controls the embedded Player expires and the Player expires with it, physically stopping the Content from being used by the Subscriber. Also it is important that the process of starting the embedded Player Streaming or presentation of other Content is tightly integrated with a necessary and concurrent Internet installment of the Browser Plug-in for that Content such as the Windows Media Plug-in used to process Windows Media format Streaming media. (Also, the embedded Player needs to correct or be made to correct buffering and bitrate requirements of the Subscriber Content or Webcast.) The same essential redirection URL security approach (See FIG. 4) is used for the embedded Player version of the Content Subscriber System but the application assigns the temporary RequestURL (See FIGS. 1 and 4) to the SRC parameter of the Player embedded in a Web page instead of Pushing it out to the Client Browser and standalone Player. In either case the RequestURL (See FIG. 1) can either be directly sent to the Client Browser and Player or sent inside a Metafile. Note that the RequestURL or Metafile Push is to the Client Browser and not directly to the standalone Player which is handed the Metafile on the Client Side as a Helper Application by the Browser. For the embedded Player version the Browser, hands the Metafile to a Plug-in which specializes in Streaming a particular format such as Windows Media. In either case the Browser cannot by itself Stream a Webcast and must also be configured to use the correct Plug-in or standalone Player to Stream a particular format.

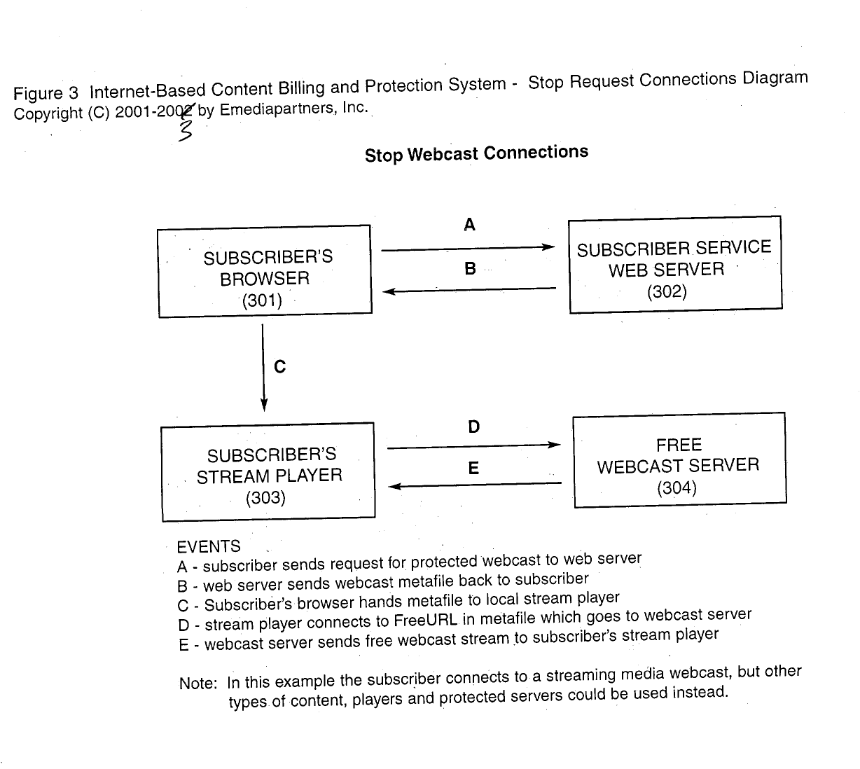

A special stop Link, for example a “Stop Billing/Webcast” Link (See Item 108 in FIG. 1) for Stream media Content, is provided on the Subscriber Control Web Page in order to remove the paid Webcast connection from the Player by replacing it with a Free Webcast (See FIG. 3). For the paid subscriber version of the Invention this is a requirement before the Subscriber can log off the account and if the Subscriber does not use the stop Link or becomes or is caused to be disconnected from the Subscriber Session through any other mechanism besides the “log out” Link on the Subscriber Control Web page then Billing remains on. In the case of a standalone Player the protected Content would continue to be accessed while it would be stopped in the case of the embedded Player. In both cases the issue of Billing remaining open would exist after termination of the Session prior to the Protected Content access being stopped. To deal with this problem a local polling program such as a Java Client can be downloaded to the Client computer and used to independently monitor whether the Session and Billing are still open. When the polling program detects that the Session has ended it sends a command to the Internet-Based Content Billing and Protection System Web Server to stop Billing and to send the free Content to the Player.

If the Content to be purchased is a static file to be downloaded then the start Link would be enabled contengent upon a fixed fee being paid up front. If the Content is an archived file based Stream then there are two options the Content Merchant may choose for Billing. One would assess the Subscriber a fixed fee up front prior to enabling access. The second would also require Credits to be purchased up front but would allow the Subscriber to stop Billing and the Stream at any point during the use of the archive.

Email receipts are sent to the Subscriber immediately after each signup, login, start Billing request, stop Billing request, and log out. These receipts may function to support arbitration of Billing disputes with the subscriber especially after an unintentional Session termination. The Subscriber is invited to send the last Session Emails to a support center where the account can be reconciled and the login reset, allowing the Subscriber to login again with the Billing off. If the Subscriber abuses the reset privilege the Subscriber account may be suspended, pending arbitration. A definite waiting time period is imposed prior to reset in order to discourage piracy and hackers.

The Web page embedded version of the application does not burden the Content Subscriber System with uncontrolled bandwidth use after a Session is terminated prior to log out since delivery of the Protected Content terminates with the Subscriber Session. In all cases it is necessary to have a Server Side system Script running regularly to hunt for dead Sessions with the Billing remaining on in order to reset the Billing to off. This would be the case where a Subscriber's computer might crash or lose power, leaving the account Billing on but the Webcast and Session both off. The actual Subscriber initiated logout (See Item 100.2 in FIG. 1) physically turns off Billing and Protected Content delivery and terminates the Subscriber Session.

One additional Server Side System Script must also be running regularly in order to search for secure Access Elements that were not properly erased by the start function described below (See Item 105 in FIG. 1). Sometimes this will happen because a Session is terminated during the 40 second secure connection handshake with the Player, however that is less likely because the secure access file erasures are carried out by a combination of a Dynamic Web Page Program initiated Web Session sleep period and a Server Side System Script that does the erasing. These secure access files can be left on the Server due to Server glitches such as file lock failures and overloading of the Server's processing capacity.

3. Web Server Reconfiguration

A Web Server reconfiguration may be required in a System File that controls whether another System File may contain directives that redirect URL requests containing a particular Web directory or subdirectory. For example, in a Linux system with an Apache Web Server the System File “/etc/httpd/conf/access.conf” can have the following four lines appended to the end of it for purposes of allowing a System File called “.htaccess” to be used for URL redirection in the home Web directory of the Subscriber application:

AccessFileName .htaccess

<Directory /home/sites/home/*>AllowOverride All

</Directory >

4. System File Permissions

A System File that controls URL redirection must have specific file permissions and ownership attributes assigned by the Web Server's operating system such that the redirection purpose of the System File cannot be defeated or otherwise circumvented by hackers or subscribers. For example, a Linux System File such as a .htaccess file is placed in the home Web directory of the Subscriber application with these file permissions:

chmod 600 chown admin chgrp home

Without these file permissions access to the Protected Content can be gained by the Client through a Server such as the Apache Web Server which maintains “child processes” that remember the final Access Path and circumvent Protect URL security.

5. Access Elements

Each Client request for access to Protected Content such as a Webcast (see Item 103 in FIG. 1) is preceeded by a Server Side creation of three Encoded access strings to be used to name and create physical Access Elements in response to the Client request (see Item 101 in FIG. 1). After this request and just prior to the working temporary Protected Content request Link being made available to the subscriber, three Access Elements are created on the Server using these Access Strings (see Item 104 in FIG. 1): 1) a temporary Metafile (such as a Windows Media Technology format ASX Metafile—see example in Appendix A) is created Server side, containing a URL reference to access a temporary access subdirectory in the Subscriber Web application, 2) the temporary access subdirectory of the form “/station/access/tempname” is created by a System Script launched by the Subscriber Client application. 3) This new empty directory is associated with a temporary Redirect Directive appended to a System File (such as a .htacess file in a Linux system) by a second System Script so launched and of the general form:

Redirect /wmr/access/wmr25948370594838760991

http://IPNUMBER/protected

Where the first part, “Redirect”, is the System File Directive name, the second part, “/station/access/station25948370594838760991”, is the access directory referenced by RequestURL (see Item 101, 104 and 106 in FIG. 1, Event D in FIG. 2, Event A in FIG. 4) used by the Player to request Protected Content, and the third part, “http://IPNUMBER/protected”, is ProtectURL (see Item 101, 106 and 107 in Fiture 1, Event D in FIG. 2, Event A in FIG. 4), the Protected Content's Protected Link to which the System File redirects RequestURL.

The redirect solution to protecting Content access may be replaced with any other mechanism whereby temporary access is made possible through the controlled existence of Access Elements (See FIG. 4). While this example using a System File is intended to refer to what is now commonly known as a URL Redirection, it is also intended to encompass variations which may be made in the future, including changes and additions to existing standard protocols and technology.

6. Access Path Protection

The Client Player is allowed to connect (see Item 1 06 in FIG. 1) to the ProtectURL (see Item 1 01 in FIG. 1 ) through a separate and temporary Link to a Metafile text file (see example file in Appendix A) that contains a reference to the access element subdirectory via a “http://Server/station/access/tempname” type URL (see “RequestURL” in FIG. 1) which then leads finally to the Server redirecting the Player to the Subscriber Webcast Protected Link via this System File redirection process (see FIG. 4). The Protected Link is the Webcast Link to be protected from use outside of the Client or Subscriber application via Bookmarking, copying, displaying or exporting by the Browsers or Player. The Protected Link to the protection Webcast Server exists as a permanent reference only in a Dynamic Web Page Program Underlay (see Item 1 in Appendix A for example) and in a Metafile source file that is itself a hidden file outside of the Subscriber application Web directory. The Dynamic Web Page Program Underlay and Overlay source code are-not in the Web page source code displayed by Browsers. In addition the Dynamic Web Page Program has a private directory facility that can allow Web files to be hidden outside of the Web document tree, making it more difficult for hackers to find them. Links to Web pages generated by a Dynamic Web Page Program are themselves Encoded and can only be used by one Subscriber and expire after a Server controlled timeout period.

7. Access Time Period

The Player is allowed to connect during a controlled time period (e.g. 40 seconds during which the Access Elements exist on the Server Side (See sleep period Item 105.2 in FIG. 1). This time period occurs during the T5 time period in FIG. 1. In the case of a Streaming media Webcast the Player connection and buffering time would typically be on the order of 20 seconds or less (see time period T6 in FIG. 1) for a broadband Stream of 96 kbps, for example. The Metafile Push to the Client Browser or SRC Assignment to the embedded Player prompts the standalone Player or Plug-in to start the connection to the Protected Content.

After a controlled Access Time Period such as 40 seconds, the Metafile access directory, and System File Redirect Directive entry are all erased (this occurs at the end of time period T5 in FIG. 1). The Metafile and access directory are erased by a Dynamic Web Page Program preloaded with a Script generated popup Web page that starts the 40 second system sleep period. The access directory is erased by a System Script called by but running outside of the main Dynamic Web Page Program application. Because the Access Path elements do not physically exist outside of the Access Time Period, it is impossible for hackers or Clients to find any kind of permanent Link to the Webcast.

8. Encoded Content Links

The entire connection process is initiated by a Client request for a special Encoded Link created by a Dynamic Web Page Program. The Link starts a process as a Filepushlink Overlay that creates an Encoded Metafile containing an Encoded access directory name, creates the access directory name, and appends a System File Redirect Directive entry all in response to the Client's request to start access to the Protected Content. In the case of a Streaming Webcast this would be, for example, a “Start Billing/Webcast”Link click (See Item 103 in FIG. 1) and just before the temporary Metafile is Pushed out to the standalone Player via the Client Browser or is assigned to the SRC URL used by a Web page embedded version of the Player (see Item 104 in FIG. 1). Creation of the temporary metafile and access directory and the redirect System File append are done inside the same Dynamic Web Page Program Overlay that Pushes or assigns the RequestURL as its last act. A System Script is called by the same Overlay to create the temporary access directory.

9. Subscriber/Client Protected Content Links

The Client initiates a request for the Protected Content via a user or Subscriber clicking a Web page Link that leads to the Client obtaining access to the Protected Content. In the case of Content intended for use by a paying Subscriber, such access is given on condition that Credits have been pre-purchased and the Client's account has not been suspended.

10. Access Path Activation

A Script (See example popup function “popup_wmrmedia( )” in Appendix A and Item 103 in FIG. 1) such as a JavaScript starts the Dynamic Web Page Program Overlay.that creates the temporary Access Path elements and Metafile Push/Link and then immediately pops up a Script generated window (see Item 1 05 in FIG. 1) that initiates the Access Time Period (e.g. 40 second sleep) and subsequently on wakeup erases the Access Elements and creates new ones for the next request. This arrangement causes the wakeup actions to be queued for execution prior to the sleep period beginning, due to the nature of a Dynamic Web Page Program and so the post sleep period access actions occur whether the Popup Box is deleted on the Client or not.

11. Player Stream Acquisition

Only during the Access Time Period (See sleep period Item 105.2 in FIG. 1) may either the standalone or embedded Player connect to the Protected Content.

The embedded Player can be made part of another Script generated Popup Box that also causes the Browser Plug-in to refresh and the Player to start after a short appropriate delay to give the Access Path Elements time to be created. This connection to the ProtectURL by the embedded Player and Plug-in is accomplished using the same URL redirection mechanism (See FIG. 4) and only during the Access Time Period just like the standalone Player version.

12. Access Path Recycling

It is important to emphasize that Dynamic Web Page Program code is queued through the Script generated Popup Box (See Item 103 in FIG. 1 ) created in response to a Client request for access to the Protected Content (e.g. “Start Billing/Webcast”) and further that this queued code only creates new Encoded Metafile and access directory names and the redirect directive string to be appended later to the redirect System File for the next connection, but are not used to create any Access Elements until the application “Start Billing/Webcast”Link is clicked on by the Subscriber again.

13. Billing

The purpose of a Subscriber Webcast includes the protection of the Protected Content Link or Links, control of the conditions for the Client's access to the Protected Link or Links, a means for metering the Client connections to the Protected Link or Links, and a means for collecting payment for use of the Protected Content. FIG. 1 illustrates how the Internet-Based Content Billing and Protection System can achieve Real Time Billing of Subscriber use of Protected Content such as Webcasts. In FIG. 1 (notated between Items 105 and 108) the time period “TX” represents the Billing time period which is estimated to be the duration of the Client Side Player connection to the ProtectURL. The Invention may or may not require that the Client gain access to the Protected Content on the condition that Credits are purchased in advance. Such purchases may or may not occur in Real Time, for example, a direct deposit-to-bank credit card Internet payment facility.

14. Conclusion

While the Invention has been described herein with reference to certain preferred embodiments, these embodiments have been presented by way of example only, and not to limit the scope of the Invention. Accordingly, the scope of Invention should be defined only in accordance with the claims that follow.

In the following claims, reference characters used to designate claim steps are provided for convenience of description only, and are not intended to imply any particular order for performing the steps, except where explicitly stated.

15. What Is New

The new items are: 1) a means to protect live Content such as Webcasts from piracy or unauthorized use, 2) a means to protect live Content such as Webcasts without the use of encryption, 3) a means to physically and functionally separate the Protected Link security versus Content delivery to the Player in as much as the Protected Link security operates on a Web Server which controls Client access to a Content Server, 4) a means to tightly integrate Protected Content access with a Billing and credit facility which all operate in concert and in Real Time as part of an Internet-based Content Billing and Protection System, ie. a means to charge Internet customers in Real Time for the delivery and actual metered use of Content while at the same time restricting the customer access to such Content while preventing piracy or access, 5) a means to charge the subsriber either a fixed fee for use of Protected Content or a fee determined in Real Time by the Subscriber's actual use of the Protected Content such as a continuous Stream Webcast.

What is claimed is:

1. A method of selling and delivering over the Internet in Real Time Protected Content, including but not limited to a live or archived Streaming media Webcast, the method comprising:
providing a Web Server system and Web site with a URL redirection mechanism whereby a Client's Content or Webcast public URL request sent to the Web Server via the Web site, is converted by the Web Server to a private URL Webcast request which the Web Server then sends to a Protected Content or Webcast Server which sends a protected Stream or other Content to the Client without the Client being able to Bookmark, copy, display, export, or otherwise make public the private URL or provide access to the protected Stream or other Content;
providing a Web site system that includes a signup registration system which allows Subscribers to electronically create a private account for purposes of using the INTERNET-BASED CONTENT BILLING AND PROTECTION SYSTEM services;
providing a Client Subscriber control Web page for purposes of electronically purchasing and spending Credits in conjunction with controlled access being granted to a Protected Webcast or other Content all in Real Time or at a later time.

2. The method of claim 1, further comprising:
in response to a Subscriber request for access to a Protected Webcast or other Content, the bringing into existence, during a controlled time period only, critical Access Elements sufficient for Webcast or other Content URL redirection to work which include: a Metafile, containing a URL referencing a Web Server access directory, a Web Server access directory, and a Redirect Directive entry in a System File.

3. The method of claim 1, further comprising:
wherein determining and recording within a computer memory Subscriber Billing based upon allowed access to a Protected Webcast or other Content as determined by either a known duration or assessed value of the Content or else measured by the time between the Subscriber's request for Billing and the Protected Webcast (or other Content) to start together and the Subscriber's subsequent request for Billing and the Protected Webcast (or other Content) to stop;
in reponse to the Subscriber's request for Billing and the Protected Webcast (or other Content) to stop, the Protected Webcast Stream (or other Content) is replaced with an alternate Webcast (or other Content) such as a Free Webcast and the calculated access time to the Protected Webcast (or other Content) is deducted from the Subscriber's account thereby allowing the Subscriber to pay only for what is used from a Credits account balance which is displayed to the Subscriber on a Subscriber control Web page.

4. The method of claim 1, further comprising:
providing an Internet-Based Content Billing and Protection System Web Server that operates the Subscriber Web site in a manner that can allow such services to be physically and functionally independent of any Content Server, allowing client use and protection of known dedicated or anonymous Webcast (or other Content) Servers and networks of Webcast (or other Content) Servers;
providing an Internet-Based Content Billing and Protection System Web Server that operates the Subscriber Web site in a manner that can allow such services to be physically and functionally independent of any electronic settlement Internet service used to collect funds such as a secure credit card banking gateway.

5. The method of claim 1, further comprising:
providing a Client Side timer function that regularly refreshes the Subscriber Web Server Session necessary to determine Subscriber Billing;
in response to the Subscriber Credits being zero or near a limit another Client Side timer function will stop billing and stop the delivery of Protected Content;
providing another Client Side timer that can after a set period of time terminate Client access to Content for the purpose of limiting the extent of Content use by the Client;
providing the Subscriber a means of physically ending the Subscriber Session by logging off the Subscriber Web site contingent upon the Subscriber first stopping Billing together with stopping the Protected Webcast or other Content.

6. The method of claim 1, further comprising:
in response to the Client or Subscriber login, Start Billing/Content request, Stop Billing/Content request, Credits purchase, account info editing, and log out, the INTERNET-BASED CONTENT BILLING AND PROTECTION SYSTEM sends Email to the Client or Subscriber, documenting the Subscriber's actions and providing receipts for use of the Protected Content;
in response to the Subscriberlogin, Start Billin/Content request, stop Billing/Content request, Credits purchase, account info editing, and log out, INTERNET-BASED CONTENT BILLING AND PROTECTION SYSTEM makes entries in Subscriber log files on the Web Server, documenting the Subscriber's actions and providing a record of purchases and use of the Protected Content.

7. The method of claim 1, further comprising:
providing for protection of Content access on the Internet where such Content may or may not be explicitly sold to a Subscriber.

8. The method of claim 1, further comprising:
in response to Subscriber Billing remaining open after termination of the Session, and prior to the Protected Content access being stopped, a local polling program can be downloaded to the Client computer and used to independently monitor whether the Session and Billing are still open. When the polling program detects that the Session has ended it sends a command to the INTERNET-BASED CONTENT BILLING AND PROTECTION SYSTEM Web Server to stop Billing and log the client or Subscriber out. Then the polling program either terminates operation of the Player or sends free Content to the Player.
